(19) United States
(12) Patent Application Publication
(10) Pub. No.: US 2024/0207868 A1
(43) Pub. Date: Jun. 27, 2024

(54) MODULAR CENTRIFUGAL SEPARATOR SYSTEM

(71) Applicant: Alfa Laval Corporate AB, LUND (SE)

(72) Inventors: Peter THORWID, SUNDBYBERG (SE); Anders EKSTRÖM, TÄBY (SE); Kasper HÖGLUND, RÖNNINGE (SE)

(73) Assignee: Alfa Laval Corporate AB, LUND (SE)

(21) Appl. No.: 18/288,417

(22) PCT Filed: Apr. 13, 2022
(86) PCT No.: PCT/EP2022/059907

§ 371 Date: Oct. 26, 2023

(30) Foreign Application Priority Data
May 12, 2021 (EP) 21173597.2

(51) Int. Cl. B04B 1/04; B04B 7/12; B04B 11/02

(52) U.S. Cl. CPC B04B 1/04; B04B 7/12; B04B 11/02

(57) ABSTRACT

In a modular centrifugal separator system and an exchangeable separation insert, a separation aid is arranged in a separation space of the separation insert. The separation aid includes a number of separation sheets, each separation sheet comprising axially extending surfaces. A fluid connection for a separated heavy phase is arranged at a first axial end portion of the insert, and a fluid connection for a liquid feed mixture is arranged at a second axial end portion of the insert.

### TECHNICAL FIELD

The invention relates to a modular centrifugal separator system and an exchangeable separation insert for a modular centrifugal separator system.

### BACKGROUND

In the field of pharmaceuticals, biopharmaceuticals, biotechnology and thereto related fields, separation of substances from a liquid mixture such as, separation of cells from a cell culture mixture, are performed in a sterile environment. Traditionally, equipment made e.g. from stainless steel has been used, which equipment is sterilised between production batches.

Lately, disposable centrifugal separation equipment made for single use, i.e. for separation of one product batch or a limited number of product batches, has been introduced. Such centrifugal separation equipment comprises a base unit configured to be reused and for no contact with the product and single use portions, which are configured to be exchangeable and to come into contact with the product.

WO 2015/181175 discloses a separator for the treatment of a flowable product by centrifugation, having a rotatable drum which delimits a centrifuging space and comprising, arranged in said drum, a means for the clarification of a product to be treated in the centrifugal field. The drum comprises an outer support and an inner drum arranged in said outer support. The means for the clarification of the product to be processed in the centrifugal field is arranged in the inner drum. The means for clarification, primarily disclosed, is a stack of axially spaced separation discs, which have a conical basic shape. Alternative means for clarification is a rib body with radial or curved ribs.

EP 3666389 discloses an exchangeable separation insert and a modular centrifugal separator. The insert comprises a rotatable rotor casing and a first stationary portion. The rotor casing delimits a separation space and comprises frustoconical separation discs therein.

### SUMMARY

It would be advantageous to achieve an alternative centrifugal separator configured for single use. In particular, it would be desirable to provide such a centrifugal separator comprising an alternative separation aiding means being arranged for gentle treatment of a liquid feed mixture flowing into and a separated heavy phase flowing out of the centrifugal separator. To better address one or more of these concerns, a modular centrifugal separator system having the features defined in one of the independent claims is provided.

According to an aspect of the invention, there is provided a modular centrifugal separator system configured for separating a liquid feed mixture into a heavy phase and light phase, the modular centrifugal separator system comprising a base unit and an exchangeable separation insert. The exchangeable separation insert comprises a rotor casing configured to rotate about a rotational axis and forming a separation space, separation aiding means arranged in the separation space, and fluid connections for the liquid feed mixture, the heavy phase, and the light phase. The separation aiding means comprises a number of separation sheets, each separation sheet comprising axially extending surfaces and having a straight or curved extension in a radial direction. The fluid connection for the heavy phase is arranged at a first axial end portion of the exchangeable separation insert and the fluid connection for the liquid feed mixture is arranged at a second axial end portion of the exchangeable separation insert.

Since the fluid connection for the heavy phase is arranged at the first axial end portion of the exchangeable separation insert, and the fluid connection for the liquid feed mixture is arranged at the second axial end portion of the exchangeable separation insert, provisions are made for the liquid feed mixture to be conducted into the exchangeable separation insert as well as the separated heavy phase to be conducted out of the exchangeable separation insert, concentrically with the rotational axis, during use of the modular centrifugal separator system. Thus, the modular centrifugal separator system is configured for gentle inflow of liquid feed mixture into, and gentle outflow of the separated heavy phase from, the exchangeable separation insert, which comprises the rotor casing i.e., the rotating part of the modular centrifugal separator system which contains the separation space.

Furthermore, it has been realised that separation sheets are easier to manufacture by injection moulding than frustoconical separation discs. For instance so, since for a particular size of separation space, each separation sheets can be made of a simpler shape and/or smaller compared to a frustoconical separation disc. Due to the exchangeability and disposable character of at least some parts of a single use centrifugal separator and separator system, injection moulding may be a preferred manufacturing method for at least some of the parts. The manufacturing of separation sheets for a modular centrifugal separator system comprising an exchangeable separation insert, by injection moulding is proposed herein.

In comparison with ribs, each separation sheet extends over a substantial axial length of the separation space, such as over at least 90% of the axial length of the separation space.

The axially extending surfaces of the separation sheets may extend in parallel with the rotational axis. However, the axially extending surfaces may also extend with a small angle relative the rotational axis, or e.g. be slightly curved in relation to the rotational axis. Each separation sheet has two axially extending surfaces, a first surface facing forwardly in a rotational direction of the rotor casing and a second surface facing rearwardly from the rotational direction of the rotor casing.

In order to provide a separation aiding means with a maximum separation surface, each separation sheet may be shaped to fit within an axial cross section of the separation space.

The separation sheets may have lower separation efficiency per surface area than separation aiding means in the form of frustoconical separation discs.

However, it has been realised by the inventors that along the same axial distance of the separation space, collectively, the number of separation sheets can provide more surface area then a stack of frustoconical separation discs. Accordingly, the possibility to provide a larger surface area compensates for the lower separation efficiency of the separation sheets. The inventors have found that this in conjunction with the simpler shape and thus easier manufacturing of the separation sheets in comparison with the frustoconical separation discs promotes the use of separation sheets.

The modular centrifugal separator system may be configured for use in the field of pharmaceuticals, biopharmaceuticals, biotechnology, and thereto related fields. In the modular centrifugal separator system, separation of substances from a liquid mixture such as separation of cells from a cell culture mixture, may be performed in a sterile environment.

In the modular centrifugal separator system, the liquid feed mixture is separated into a liquid heavy phase and liquid light phase. For instance, the liquid feed mixture may be formed by a cell culture mixture such as a fermentation broth including a cell culture. The light phase may be formed by fermentation broth without the cells or with only a minimum rest amount of cells and/or cell debris. The heavy phase may comprise the cells and cell debris suspended in fermentation broth.

The base unit is configured for repeated use with different exchangeable separation insert. That is, the base unit is reusable with new exchangeable parts such as the exchangeable separation insert after one process batch or after a limited number of process batches.

The exchangeable separation insert is configured for single use i.e., for separation of one batch only or a limited number of batches of liquid feed mixture.

The exchangeable separation insert may comprise first and second stationary portions, one arranged at each axial end of the rotor casing. The first and second stationary portions may comprise fluid connections for the liquid feed mixture and the heavy and light phases. As such, the exchangeable separation insert may form a main exchangeable part of the modular centrifugal separator system.

Alternatively, the modular centrifugal separator system may comprise further exchangeable parts beside the exchangeable separation insert. For instance, the exchangeable separation insert may form the only rotating exchangeable part of the modular centrifugal separator system, which further comprises exchangeable stationary parts. Examples of such exchangeable stationary parts are first and second exchangeable tube kits configured to be arranged at each axial end of the exchangeable separation insert. The first and second exchangeable tube kits may comprise fluid connections for the liquid feed mixture and the heavy and light phases. Fluid interfaces are provided between respective of the first and second exchangeable tube kits and the exchangeable separation insert. Thus, the fluid interface may form an interface between rotating and stationary parts of the modular centrifugal separator system.

Herein, the modular centrifugal separator system may also be referred to as separator system or system and the exchangeable separation insert may also be referred to as separation insert or insert.

The base unit comprises basic components for supporting the separation insert. The base unit is configured for rotating the rotor casing of the separation insert e.g., by supporting the separation insert in a rotatable member of the base unit. The rotatable member may be supported in a stationary frame of the base unit. Such a stationary frame may be stationary in the sense that it is stationary during use of the modular centrifugal separator system.

During use of the modular centrifugal separator system the liquid feed mixture is separated into the light and heavy phases in the exchangeable separation insert. More specifically, as the rotor casing is rotated about its rotational axis, the gravitational field generated by the rotation will cause the liquid feed mixture in the separation space to separate into the light and heavy phases. That is, the exchangeable separation insert is that part of the modular centrifugal separator system wherein separation takes place during use thereof.

Exchangeable parts of the modular centrifugal separator system such as, the exchangeable separation insert and optionally, further exchangeable parts may be configured to form the only parts of the modular centrifugal separator system, which are in contact with one or more of the liquid feed mixture, the heavy phase, and light phase during use of the separator system.

The exchangeable parts of the modular centrifugal separator system such as, the exchangeable separation insert and optionally, further exchangeable parts, at least portions thereof such as the rotor casing and/or the separation sheets may be manufactured from a plastic material. They may be manufactured by injection moulding.

The exchangeable separation insert may be provided to a user as a sterile entity. That is, at least the insides of the separation insert are sterile. Thus, the user will readily have available a centrifugal separator system with a sterile environment for separation of the liquid feed mixture.

The exchangeable separation insert may be mounted in the base unit by the user.

Herein, the terms mount and mounting of a part generally relates to installation of the relevant part in the base unit.

According to embodiments, the separation space has at least two different portions with different shapes as seen in an axial plane, and wherein the separation aiding means has an outer edge that follows the shape of the two different portions. The axial plane has thus a normal that is perpendicular to the rotational axis. Having a separation space with two such different portions may lead to an improved flow profile within the separation space. Further, by having separation aiding means with an outer edge that follows the shape of the separation space further optimizes the overall separation area within the separation space, with a small sludge space radially outside the separation aiding means.

According to embodiments, the separation space may have an axial portion having a cylindrical shape or a frustoconical shape with a maximum apex angle of 20 degrees. In this manner large separation sheets may be fitted at least within the axial portion of the separation space. More specifically, each of the separation sheets may comprise large surface areas due to the separation sheet being able to have a broadly seen square shape in the portion thereof extending through the axial portion.

According to a further aspect, there is provided an exchangeable separation insert for a modular centrifugal separator according to any one of aspects and/or embodiments discussed herein. The exchangeable separation insert comprises a rotor casing configured to rotate about a rotational axis and forming a separation space, separation aiding means arranged in the separation space, and fluid connections for a liquid feed mixture, the heavy phase, and the light phase. The separation aiding means comprises a number of separation sheets, each separation sheet comprising axially extending surfaces and having a straight or curved extension in a radial direction. The fluid connection for the heavy phase is arranged at a first axial end portion of the exchangeable separation insert, and the fluid connection for the liquid feed mixture is arranged at a second axial end portion of the exchangeable separation insert.

As discussed above in connection with the modular centrifugal separator system, since the fluid connection for the heavy phase is arranged at the first axial end portion of the exchangeable separation insert, and the fluid connection for the liquid feed mixture is arranged at the second axial end portion of the exchangeable separation insert, provisions are made for the liquid feed mixture to be conducted into the exchangeable separation insert as well as the separated heavy phase to be conducted out of the exchangeable separation insert, concentrically with the rotational axis. Thus, the exchangeable separation insert is configured for gentle inflow of liquid feed mixture into, and gentle outflow of the separated heavy phase from, the exchangeable separation insert, which comprises the rotor casing i.e., the rotating part of the modular centrifugal separator system which contains the separation space.

According to embodiments, the exchangeable separation insert may comprise a holder element arranged concentrically with the rotational axis. One radial end of each of the separation sheets may be attached to the holder element. In this manner, the separation sheets may be secured within the separation space of the exchangeable separation insert.

According to a further aspect of the invention, there is provided a modular centrifugal separator system configured for separating a liquid feed mixture into a heavy phase and light phase, the modular centrifugal separator system comprising a base unit and an exchangeable separation insert. The exchangeable separation insert comprises a rotor casing configured to rotate about a rotational axis and forming a separation space, separation aiding means arranged in the separation space, and fluid connections for the liquid feed mixture, the heavy phase, and the light phase. The separation aiding means comprises a number of separation sheets, each separation sheet comprising axially extending surfaces and having a straight or curved extension in a radial direction.

As discussed above, the separation sheets are of a simpler shape and thus, easier to manufacture than separation aiding means in the form of frustoconical separation discs.

Also, since the separation aiding means comprising the number of separation sheets provides for that along the same axial distance, the number of separation sheets can provide more surface area then a stack of frustoconical separation discs, the lower separation efficiency of the separation sheets in comparison with frustoconical separation discs is compensated for.

The modular centrifugal separator system according to this aspect may be devised in accordance with embodiments of other aspects of the modular centrifugal separator system and/or other aspects of the exchangeable separation insert discussed herein.

According to a further aspect of the invention, there is provided an exchangeable separation insert for a modular centrifugal separator according to any one of aspects and/or embodiments discussed herein. The exchangeable separation insert comprises a rotor casing configured to rotate about a rotational axis and forming a separation space, separation aiding means arranged in the separation space, and fluid connections for a liquid feed mixture, the heavy phase, and the light phase. The separation aiding means comprises a number of separation sheets, each separation sheet comprising axially extending surfaces and having a straight or curved extension in a radial direction.

The exchangeable separation insert according to this aspect may be devised in accordance with embodiments of other aspects of the modular centrifugal separator system and/or other aspects of the exchangeable separation insert discussed herein.

Further features of, and advantages with, the invention will become apparent when studying the appended claims and the following detailed description.

### BRIEF DESCRIPTION OF THE DRAWINGS

Various aspects and/or embodiments of the invention, including its particular features and advantages, will be readily understood from the example embodiments discussed in the following detailed description and the accompanying drawings, in which:

FIGS. 1a and 1b schematically illustrate embodiments of a modular centrifugal separator system and an exchangeable separation insert,

FIG. 2 schematically illustrates a cross section through a base unit of a modular centrifugal separator system,

FIG. 3 schematically illustrates a cross-section through an exchangeable separation insert according to embodiments,

FIGS. 4a-4c schematically illustrate embodiments of separation aiding means, and

FIG. 5 schematically illustrates a cross section through a portion of a modular centrifugal separator system.

### DETAILED DESCRIPTION

Aspects and/or embodiments of the invention will now be described more fully. Like numbers refer to like elements throughout. Well-known functions or constructions will not necessarily be described in detail for brevity and/or clarity.

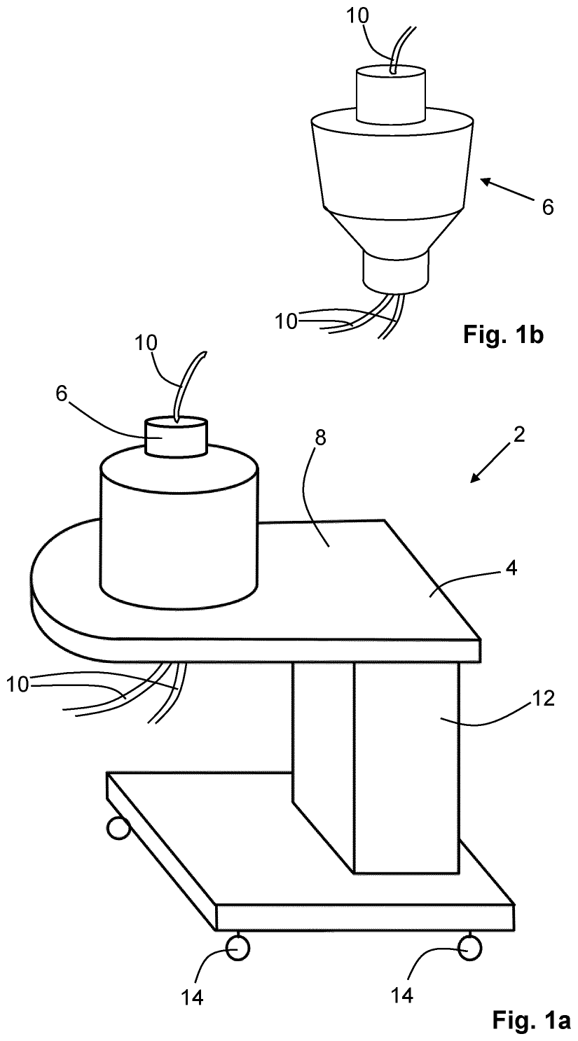

FIGS. 1a and 1b schematically illustrate a modular centrifugal separator system 2 according to embodiments and embodiments of an exchangeable separation insert 6 for a modular centrifugal separator system 2.

The modular centrifugal separator system 2 comprises a base unit 4 and an exchangeable separation insert 6. The modular centrifugal separator system 2 may be configured for use in the field of pharmaceuticals, biopharmaceuticals, and/or biotechnology. The modular centrifugal separator system 2 may form part of a set-up in a plant for the production of cells, such as CHO cells (Chinese Hamster Ovary cells) or other matter resulting from processes in the pharmaceutical or biotech industry.

The separator system 2 is configured for separating a liquid feed mixture into a heavy phase and light phase.

The modular centrifugal separator system 2 is modular in the sense that it comprises the base unit 4 and the exchangeable separation inserts 6. The exchangeable separation insert 6 is exchanged for each new batch of liquid feed mixture, which is to be separated. Alternatively, the exchangeable separation insert 6 may be exchanged for each new type of liquid feed mixture, which is to be separated, i.e. subsequent batches containing same type of liquid feed mixtures may be separated with the same exchangeable separation insert 6. Optionally, the modular centrifugal separator system 2 may comprise further exchangeable parts, which are exchanged for each new batch of liquid feed mixture or each new type of liquid feed mixture.

During use of the modular centrifugal separator system 2 the liquid feed mixture, the heavy phase, and the light phase only come into contact with the exchangeable separation insert 6 of the modular centrifugal separator system 2. Naturally, conduits in the form of tubes 10 configured for conducting the liquid feed mixture to the exchangeable separation insert 6 and for conducting the heavy phase and the light phase from the exchangeable separation insert 6 also come into contact with the liquid feed mixture and the heavy and light phases. The tubes 10 may form part of the exchangeable separation insert 6. The base unit 4 does not come into contact with the liquid feed mixture or any of the heavy and light phases.

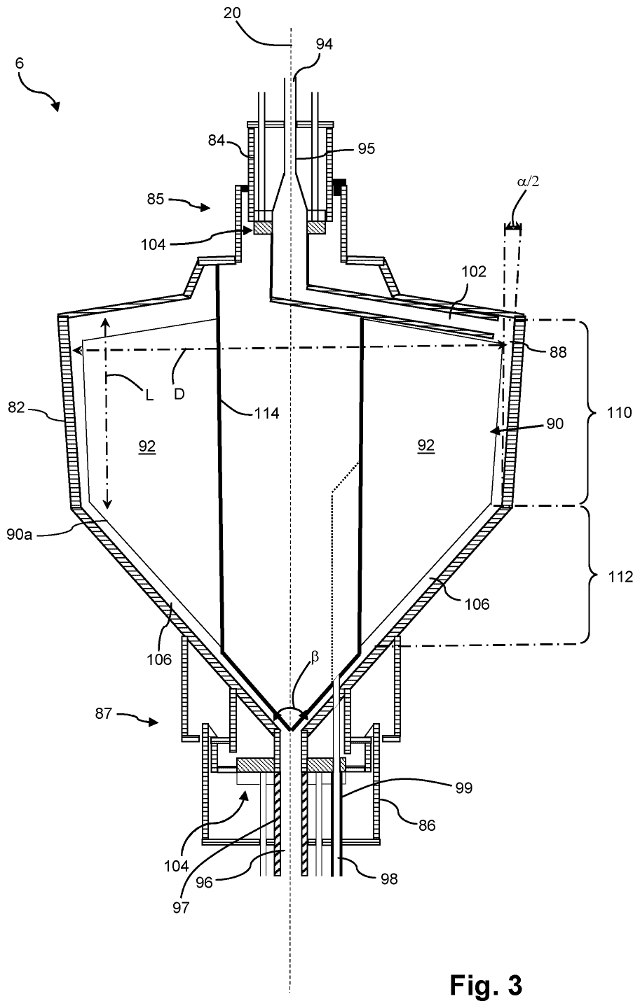

The exchangeable separation insert 6 is further discussed below with reference to FIG. 3.

The base unit 4 comprises components for supporting and rotating the exchangeable separation insert 6. Thus, the base unit 4 comprises inter alia a stationary frame 8, a rotatable member, and a drive unit for rotating the rotatable member. The stationary frame 8 comprises a vertical member 12. Part of the drive unit may be arranged in the vertical member 12.

The stationary frame 8 is stationary during use of the separator system. However, the base unit 4 as such may be movable e.g., in order to be positioned at different locations at a production facility of the user. For this purpose, the stationary frame 8 may be provided with wheels 14.

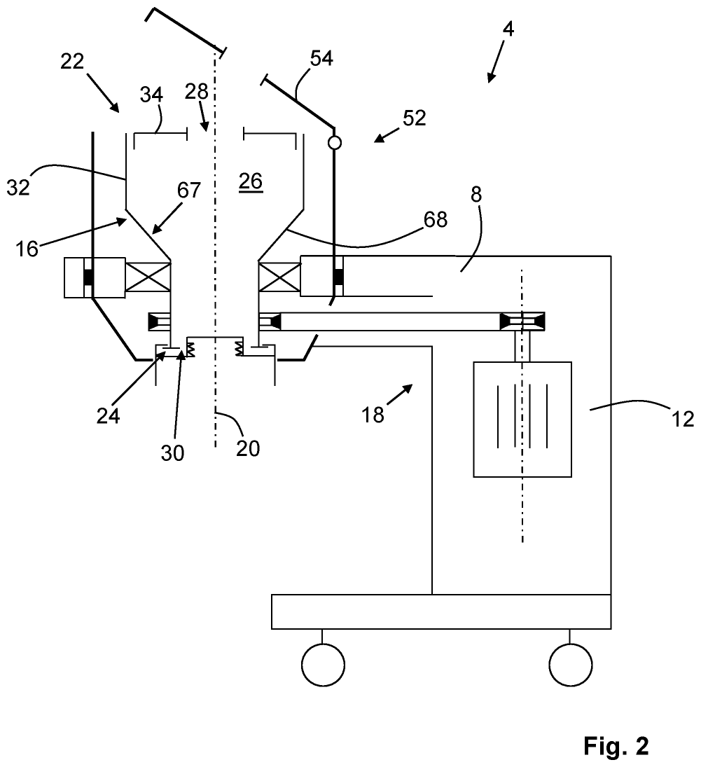

The base unit 4 is further discussed below with reference to FIG. 2.

FIG. 2 schematically illustrates a cross section through a base unit 4 of a modular centrifugal separator system. That is, in FIG. 2 the exchangeable separation insert has been omitted. The modular centrifugal separator system may be a modular centrifugal separator system 2 as shown in FIG. 1.

As mentioned above, the base unit 4 comprises the stationary frame 8, the rotatable member 16, and the drive unit 18. The rotatable member 16 is arranged in the stationary frame 8 and is configured to rotate about a rotational axis 20. The drive unit 18 is configured for rotating the rotatable member 16 about the rotational axis 20.

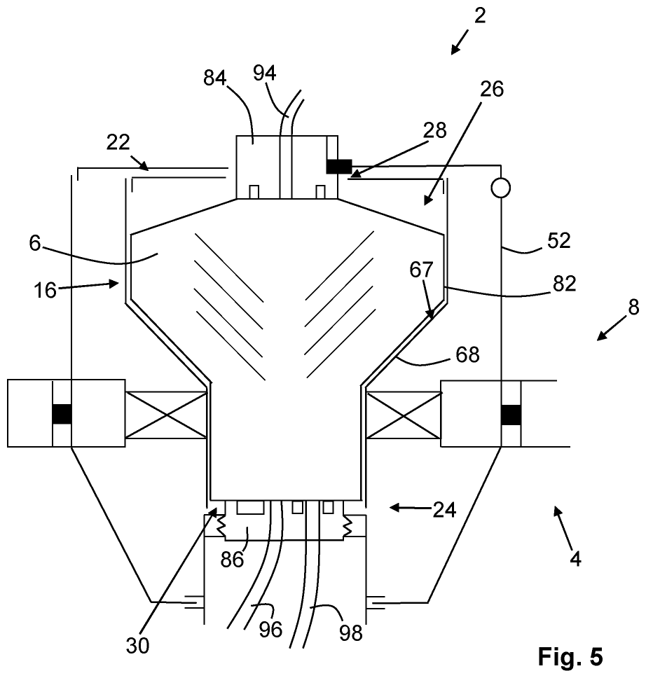

Seen along the rotational axis 20, the rotatable member 16 has a first axial end 22 and a second axial end 24. The rotatable member 16 delimits an inner space 26 at least in a radial direction. The radial direction extends perpendicularly to the rotational axis 20. The inner space 26 is configured for receiving at least one part of the exchangeable separation insert therein, see further with reference to FIGS. 3 and 5 below.

The rotatable member 16 is provided with a first opening 28 at the first axial end 22. The rotatable member 16 further is provided with a second opening 30 at the second axial end 24. Each of the first and second openings 28, 30 forms a through hole in the rotatable member 16. Thus, the inner space 26 is accessible via each of the first and second openings 28, 30. Accordingly, the first and second openings 28, 30 are configured for fluid connections of the exchangeable separation insert to extend therethrough. See further with reference to FIGS. 3 and 5 below.

Access to the inner space 26 is provided via a cap 34. Thus, the exchangeable separation insert may be mounted in and removed from the inner space 26. The rotatable member 16 is arranged inside a stationary housing 52. The housing 52 comprises a lid 54. In an open position of the lid 54, access is provided to the rotatable member 16 inside the housing 52 e.g., for exchange of the separation insert.

The inner space 26 of the rotatable member 16 is delimited at least in part by an inner surface 67. The separation insert has a same external shape to an extent that it fits inside the inner space 26. The separation insert, when fitted in the inner space 26 abuts against at least part of the inner surface 67. Thus, the separation insert is supported in the inner space 26.

In the illustrated embodiments, the rotatable member 16 comprises a frustoconical wall member 68 having an imaginary apex in a region of the second axial end 24. The frustoconical wall member 68 delimits a portion of the inner space 26 and comprises the inner surface 67. When positioned in the inner space 26, an exchangeable separation insert having a conical or frustoconical shape may be supported by the frustoconical wall member 68.

According to alternative embodiments, rotatable member may have more of a cylindrical shape. In such embodiments, a cylindrical wall member and/or a radially extending wall member which delimits a portion of the inner space 26 and comprises the inner surface 67. When positioned in the inner space 26, an exchangeable separation insert having a cylindrical or substantially cylindrical shape may be supported by the cylindrical wall member and/or the radially extending wall member.

According to alternative embodiments, the rotatable member 16 may be provided with only the first opening 28 or only the second opening 30, in which case all fluid connections of the exchangeable separation insert extend only through the relevant first or second opening 28, 30. For instance, according to aspects of the separator system 2 and the separation insert 6 related to separation sheets arranged in a separation space of the separation insert 6 as discussed below, and the particular advantages of the separation sheets, it is not necessary for fluid connections to be provided at both axial ends of the separation insert 6.

FIG. 3 schematically illustrates a cross-section through an exchangeable separation insert 6, according to embodiments. The exchangeable separation insert 6 may form part of a modular centrifugal separator system, such as the modular centrifugal separator system 2 discussed above in connection with FIG. 1a. Accordingly, the illustrated exchangeable separation insert 6 exemplifies an embodiment of the exchangeable separation insert 6 discussed above with reference to FIG. 1b.

The exchangeable separation insert 6 is configured for part of it to be arranged inside an inner space 26 of a rotatable member 16 of a base unit, e.g. a base unit 4 as discussed above in connection with FIG. 2.

The exchangeable separation insert 6 comprises a rotor casing 82, a first stationary portion 84 arranged at a first axial end portion 85 of the separation insert 6, and a second stationary portion 86 arranged at a second axial end portion 87 of the separation insert 6. The rotor casing 82 is configured to rotate about a rotational axis 20. The rotor casing 82 is arranged between the first stationary portion 84 and the second stationary portion 86. During operation of the modular centrifugal separator, the first stationary portion 84 is arranged at an upper axial end of the exchangeable separation insert 6, whereas the second stationary portion 86 is arranged at a lower axial end of the exchangeable separation insert 6.

The rotor casing 82 forms a separation space 88. That is, the rotor casing 82 delimits the separation space 88 therein. The exchangeable separation insert 6 comprises separation aiding means 90 arranged in the separation space 88.

The separation aiding means 90 comprises a number of separation sheets 92. Each separation sheet 92 comprises axially extending surfaces and having a straight or curved extension in a radial direction. The radial direction extends perpendicularly to the rotational axis 20. The separation aiding means 90 may comprise at least 50 separation sheets 92, such as at least 100 separation sheets 92. The separation sheets 92 are attached to a holder element 114. The separation space 88 has two different axial portions 110, 112 with different shapes as seen in an axial plane. As seen in FIG. 3, the separation aiding means 90 has an outer edge 90a that follows the shape of the two different portions 110, 112. This means that the radial distance between the edge 90a and the inner wall of the rotor casing 82 is substantially constant within the two axial portions 110, 112.

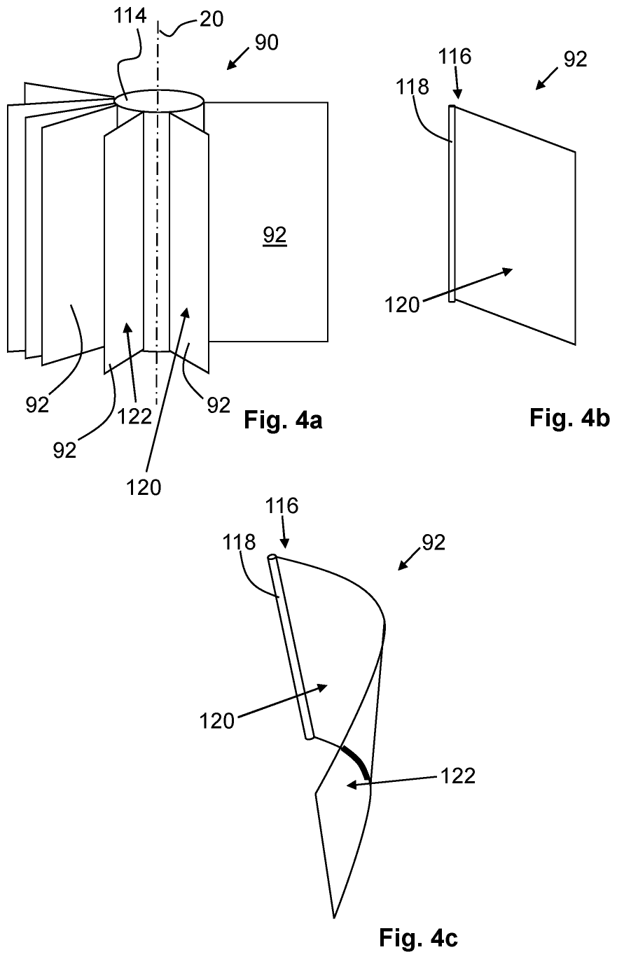

The separation sheets 92 are further discussed below with reference to FIGS. 4a-4c.

The exchangeable separation insert 6 further comprises fluid connections 94, 96, 98 for the liquid feed mixture, the heavy phase, and the light phase. The fluid connection 94 for the heavy phase is arranged at the first axial end portion 85 of the exchangeable separation insert 6, and the fluid connection 96 for the liquid feed mixture is arranged at the opposite axial end portion 87 of the exchangeable separation insert 6.

Since the fluid connections 94, 96 for the separated heavy phase and the liquid feed mixture are arranged at opposite axial end portions 85, 87 of the exchangeable separation insert 6, both the separated heavy phase and the liquid feed mixture can be conducted out of and into the rotor casing 82 concentrically with the rotational axis 20. Thus, gentle outflow of the separated heavy phase from, and gentle inflow of liquid feed mixture into, the rotor casing 82 and the separation space 88 is provided.

According to alternative embodiments, the fluid connection for the liquid feed mixture may be provided at the first axial end portion 85 and the fluid connection for the separated heavy phase may be provided at the second axial end portion 87.

In the illustrated embodiments the fluid connection 98 for the separated light phase is provided at the second axial end portion 87. In alternative embodiments, the fluid connection for the separated light phase may be provided at the first axial end portion 85.

In more detail, the exchangeable separation insert 6 comprises a first fluid connection 94 arranged at the first stationary portion 84. A first conduit portion 95 forms part of the first fluid connection 94. The first conduit portion 95 of the first fluid connection 94 extents through the first stationary portion 84. The exchangeable separation insert 6 comprises a second fluid connection 96 arranged at the second stationary portion 86. A second conduit portion 97 forms part of the second fluid connection 96. The second conduit portion 97 of the second fluid connection 96 extents through the second stationary portion 86. In these embodiments, the exchangeable separation insert 6 comprises a third fluid connection 98 arranged at the second stationary portion 86. A third conduit portion 99 forms part of the third fluid connection 98. The third conduit portion 99 of the third fluid connection 98 extents through the second stationary portion 86. Inside the rotor casing 82 there are arranged one or more outlet conduits 102 for the separated heavy phase from the separation space 88. The first, second, and third fluid connections 94, 96, 98 may comprise tubing, such as plastic tubing.

The first stationary portion 84 abuts against the rotor casing 82. The second stationary portion 86 abuts against the rotor casing 82. Seals 104 are provided between the respective first and second stationary portions 84, 86 and the rotor casing 82. The seals 104 form mechanical seals between the stationary portions 84, 86 and the rotor casing 82. Thus, the exchangeable separation insert 6 is provided with mechanically hermetically sealed inlet and outlets. A mechanical hermetical seal includes an abutment between part of the rotatable rotor casing and a stationary portion.

During operation, the exchangeable separation insert 6 arranged in the rotatable member 16 of the base unit 4, is brought into rotation around the rotational axis 20. Liquid feed mixture to be separated is supplied via the second fluid connection 96 arranged in the second stationary portion 86 and guiding channels 106 into the separation space 88. The liquid feed mixture to be separated is guided along an axially upward path into the separation space 88 in between the separation sheets 92. Due to a density difference, the liquid feed mixture is separated into a liquid light phase and a liquid heavy phase. This separation is facilitated by the interspaces between the separation sheets 92 and the surfaces of the separation sheets 92 fitted in the separation space 88. The heavy phase may comprise particles, such as e.g. cells. The heavy phase may comprise a concentrated mixture of light phase and particles.

The separated liquid heavy phase is collected from the periphery of the separation space 88 via outlet conduit 102 and is forced out of the rotor casing 82 to the first fluid connection 94 arranged in the first stationary portion 84. Separated liquid light phase is forced radially inwardly between the separation sheets 92 and led out of the rotor casing 82 to the third fluid connection 98 arranged in the second stationary portion 86. Consequently, in this embodiment, the liquid feed mixture is supplied at a lower axial end of the exchangeable separation insert 6, the separated light phase is discharged at the lower axial end, and the separated heavy phase is discharged at the upper axial end of the exchangeable separation insert 6.

According to alternative embodiments, the exchangeable separation insert 6 may comprise only the first or second stationary portion 84, 86. In such embodiments, the first, second, and third fluid connections 94, 96, 98 are provided at the first or second stationary portion 84, 86, respectively.

The separation space 88 has an axial portion 110 having a cylindrical shape or a frustoconical shape with a maximum apex angle a of 20 degrees. Thus, the separation sheets 92 having large surface areas fit inside the separation space 88. In FIG. 3 half the apex angle a is indicated.

According to embodiments, the axial portion 110 may have a ratio between its diameter, D, and axial length, L, within a range of 2:1-1:4, and the separation sheets 92 extend axially and radially within the axial portion 110 of the separation space 88. In this manner, separation sheets 92 having a large surface area may be provided in the separation space 88.

In case the axial portion 110 has a frustoconical shape, an average diameter may be utilised for calculating the above mentioned ratio.

In the illustrated embodiments, the separation space 88 has a further axial portion 112. The further axial portion 112 has a conical shape with an apex angle b within a range of 90-175 degrees and adjoins with its base to the cylindrical shape or a narrow end of the frustoconical shape of the axial portion 110. The separation sheets 92 extend axially and radially within the separation space 88 in the further axial portion 112. In this manner, the separation sheets 92 may be arranged to extend into a conically shaped portion of the separation space 88.

FIGS. 4a-4c schematically illustrate embodiments of separation aiding means 90. The separation aiding means 90 may form part of an exchangeable separation insert 6 as discussed above with reference to FIGS. 1a, 1b, and 3. In FIG. 4a the separation sheets 92 are shown attached to a holder element 114. In FIGS. 4b and 4c individual separation sheets 92 according to two different embodiments are shown.

The separation aiding means 90 comprises a number of separation sheets 92. Each separation sheet 92 comprises axially extending surfaces 120, 122. The separation sheet 92 may have a straight extension in the radial direction as shown in FIGS. 4a and 4b or a curved extension in the radial direction as shown in FIG. 4c. The radial direction extends perpendicularly to the rotational axis 20.

The number of separation sheets 92 may be large, such as at least 50 separation sheets 92 or at least 100 separation sheets 92. Only a few of the number of separation sheets 92 are shown in FIG. 4a. The separation sheets 92 may comprise a metal or be of metal material, such as stainless steel. The separation sheets 92 may further comprise a plastic material or alternatively, be of a plastic material. The separation sheets 92 may be manufactured from a plastic material by injection moulding.

The holder element 114 is configured to be arranged concentrically with the rotational axis 20 of the separation insert. One radial end 116 of each of the separation sheets 92 is attached to the holder element 114. For this purpose, the radial end 116 of the separation sheet 92 may be provided with a suitable attachment member 118 and the holder element 114 may be provided with an engaging element for each separation sheet 92. The engaging element is configured to engage with the attachment member 118.

Purely as an example, in the illustrated embodiments, the attachment member 118 may comprise an elongated member having a larger diameter or mean diameter than the thickness or mean thickness of the separation sheet 92. The engaging element (not shown) is configured to receive therein the elongated member and is provided with an axially extending slot, through which the separation sheet 92 extends radially from the engaging element and the holder element 114.

The axially extending surfaces 120, 122 of the separation sheets 92 extend substantially in parallel with the rotational axis 20. The separation sheets 92 have simple shape in comparison with frustoconical separation discs.

FIG. 5 schematically illustrates a cross section through a portion of a modular centrifugal separator system 2. More specifically, FIG. 5 shows a cross section through a housing 52, a rotatable member 16, and an exchangeable separation insert 6 of the modular centrifugal separator system 2. The modular centrifugal separator system 2 may be a modular centrifugal separator system 2 as discussed above in connection with FIGS. 1a-3. The exchangeable separation insert 6 may be an exchangeable separation insert 6 as discussed above in connection with FIGS. 1a-3, which may comprise a separation aid 90 as discussed with reference to FIGS. 4a-4c. Accordingly, in the following, reference is also made to FIGS. 1a-4c.

In FIG. 5 the exchangeable separation insert 6 is shown mounted in the base unit 4. Part of the exchangeable separation insert 6 is received in the inner space 26 of the rotatable member 16.

The inner space 26 of the rotatable member 16 is delimited at least in part by an inner surface 67. The inner space 26 is configured for receiving at least one part of the exchangeable separation inserts 6 therein. For instance, and as also mentioned above with reference to FIG. 2, the rotatable member 16 comprises a frustoconical wall member 68 which forms part of the inner surface 67. A portion of the exchangeable separation insert 6 has a conical or frustoconical shape. The conical or frustoconical portion of the exchangeable separation insert 6 is supported by the frustoconical wall member 68.

During use of the modular centrifugal separator 2, the first stationary portion 84 is fixed in relation to the stationary frame 8 and the second stationary portion 86 is fixed in relation to the stationary frame 8.

In the illustrated embodiments, the rotatable member 16 has a first axial end 22 and a second axial end, and the rotatable member 16 is provided with a first opening 28 at the first axial end 22 configured for at least a first fluid connection 94 of the exchangeable separation insert 6 to extend through the first opening 28. In this manner, the first fluid connection 94 may be arranged for extending into or out of the rotatable member 16.

In the illustrated embodiments, the rotatable member 16 comprises a second opening 30 at the second axial end 24 configured for at least a second fluid connection 96 of the first or second exchangeable separation insert 6 to extend through the second opening 30. In this manner, the second fluid connection 96 may be arranged for extending into or out of the rotatable member 16.

In the illustrated embodiments, a third fluid connection 98 of the first or second exchangeable separation insert 6 may extend through the second opening 30.

According to alternative embodiments, the third fluid connection 98 of the first or second exchangeable separation insert 6 may extend through the first opening 28.

According to further alternative embodiments, only the first or second opening 28, 30 is provided in the rotatable member and all fluid connections of the first or second exchangeable separation insert 6 extend through the first or second opening 28, 30 respectively.

It is to be understood that the foregoing is illustrative of various example embodiments and that the invention is defined only by the appended claims. A person skilled in the art will realize that the example embodiments may be modified, and that different features of the example embodiments may be combined to create embodiments other than those described herein, without departing from the scope of the invention, as defined by the appended claims.

For instance, the invention is neither limited to an exchangeable separation insert comprising first and the second stationary portions nor limited to a modular centrifugal separator system comprising such an exchangeable separation insert. As mentioned initially, the modular centrifugal separator system may comprise further exchangeable parts beside the exchangeable separation insert. For instance, the exchangeable separation insert may form the only rotating exchangeable part of the modular centrifugal separator system, which separator system comprises further exchangeable stationary parts. Examples of such exchangeable stationary parts may be first and second exchangeable tube kits configured to be arranged at each axial end of the exchangeable separation insert. The first and second exchangeable tube kits may comprise fluid connections for the liquid feed mixture and the heavy and light phases.

1. A modular centrifugal separator system configured for separating a liquid feed mixture into a heavy phase and a light phase, the modular centrifugal separator system comprising a base unit and an exchangeable separation insert,
wherein the exchangeable separation insert comprises:
a rotor casing configured to rotate about a rotational axis, the rotor casing forming a separation space;
a separation aid arranged in the separation space; and
fluid connections for the liquid feed mixture, the heavy phase, and the light phase,
wherein the separation aid comprises a number of separation sheets, each separation sheet comprising axially extending surfaces and having a straight or a curved extension in a radial direction,
wherein the fluid connection for the heavy phase is arranged at a first axial end portion of the exchangeable separation insert, and
wherein the fluid connection for the liquid feed mixture is arranged at a second axial end portion of the exchangeable separation insert.

2. The modular centrifugal separator system according to claim 1, wherein the separation space has at least two different portions with different shapes as seen in an axial plane, and wherein the separation aid has an outer edge that follows a shape of the at least two different portions.

3. The modular centrifugal separator system according to claim 1, wherein the separation space has an axial portion having a cylindrical shape or a frustoconical shape with a maximum apex angle (a) of 20 degrees.

4. The modular centrifugal separator system according to claim 3, wherein the axial portion has a ratio between a diameter (D) and an axial length (L) within a range of 2:1-1:4, and
wherein the separation sheets extend axially and radially within the axial portion of the separation space.

5. The modular centrifugal separator system according to claim 3, wherein the separation space has a further axial portion,
wherein the further axial portion has a conical shape with an apex angle (b) within a range of 90-175 degrees, the further axial portion adjoining with a base thereof to the cylindrical shape or a narrow end of the frustoconical shape of the axial portion, and
wherein the separation sheets extend axially and radially within the separation space in the further axial portion.

6. An exchangeable separation insert for a modular centrifugal separator system comprising:
a rotor casing configured to rotate about a rotational axis, the rotor casing forming a separation space;
a separation aid arranged in the separation space; and
fluid connections for a liquid feed mixture, heavy phase, and a light phase,
wherein the separation aid comprises a number of separation sheets, each separation sheet comprising axially extending surfaces and having a straight or a curved extension in a radial direction,
wherein the fluid connection for the heavy phase is arranged at a first axial end portion of the exchangeable separation insert, and
wherein the fluid connection for the liquid feed mixture is arranged at a second axial end portion of the exchangeable separation insert.

7. The exchangeable separation insert according to claim 6, further comprising a first stationary portion arranged at the first axial end portion and a second stationary portion arranged at the second axial end portion,
wherein the fluid connection for the heavy phase is arranged at the first stationary portion and the fluid connection for the liquid feed mixture is arranged at the second stationary portion.

8. The exchangeable separation insert according to claim 6, wherein the separation space has an axial portion having a cylindrical shape or a frustoconical shape with a maximum apex angle (a) of 20 degrees.

9. The exchangeable separation insert according to claim 8, wherein the axial portion has a ratio between a diameter (D) and an axial length (L) within a range of 2:1-1:4, and
wherein the separation sheets extend axially and radially within the axial portion of the separation space.

10. The exchangeable separation insert according to claim 8, wherein the separation space has a further axial portion,
wherein the further axial portion has a conical shape with an apex angle (b) within a range of 90-175 degrees, the further axial portion adjoining with a base thereof to the cylindrical shape or a narrow end of the frustoconical shape of the axial portion, and
wherein the separation sheets extend axially and radially within the separation space in the further axial portion.

11. The exchangeable separation insert according to claim 7, comprising a holder element arranged concentrically with the rotational axis, wherein one radial end of each of the separation sheets is attached to the holder element.

12. The modular centrifugal separator system according to claim 2, wherein the separation space has an axial portion having a cylindrical shape or a frustoconical shape with a maximum apex angle (a) of 20 degrees.

13. The modular centrifugal separator system according to claim 4, wherein the separation space has a further axial portion,
wherein the further axial portion has a conical shape with an apex angle (b) within a range of 90-175 degrees, the further axial portion adjoining with a base thereof to the cylindrical shape or a narrow end of the frustoconical shape of the axial portion, and
wherein the separation sheets extend axially and radially within the separation space in the further axial portion.

14. The exchangeable separation insert according to claim 7, wherein the separation space has an axial portion having a cylindrical shape or a frustoconical shape with a maximum apex angle (a) of 20 degrees.

15. The exchangeable separation insert according to claim 9, wherein the separation space has a further axial portion,
wherein the further axial portion has a conical shape with an apex angle (b) within a range of 90-175 degrees, the further axial portion adjoining with a base thereof to the cylindrical shape or a narrow end of the frustoconical shape of the axial portion, and
wherein the separation sheets extend axially and radially within the separation space in the further axial portion.

16. The exchangeable separation insert according to claim 8, comprising a holder element arranged concentrically with the rotational axis, wherein one radial end of each of the separation sheets is attached to the holder element.

17. The exchangeable separation insert according to claim 9, comprising a holder element arranged concentrically with the rotational axis, wherein one radial end of each of the separation sheets is attached to the holder element.

18. The exchangeable separation insert according to claim 10, comprising a holder element arranged concentrically with the rotational axis, wherein one radial end of each of the separation sheets is attached to the holder element.
